(19) United States
(12) Patent Application Publication
(10) Pub. No.: US 2024/0402985 A1
(43) Pub. Date: Dec. 5, 2024

(54) BEAT AND DOWNBEAT ESTIMATION AND PLAYBACK

(71) Applicant: MOISES SYSTEMS, INC., Salt Lake City, UT (US)

(72) Inventors: Hugo Rodrigues, Salt Lake City, UT (US); Geraldo Ramos, Salt Lake City, UT (US); Filip Korzeniowski, Vienna (AT)

(21) Appl. No.: 18/677,322

(22) Filed: May 29, 2024

Related U.S. Application Data
(60) Provisional application No. 63/504,951, filed on May 30, 2023.

(51) Int. Cl. G06F 3/16; G04F 5/02; G10H 1/00

(52) U.S. Cl. CPC G06F 3/165; G10H 1/0008; G04F 5/025; G10H 2210/076; G10H 2220/005

(57) ABSTRACT

A system may be configurable to (i) access an audio signal, (ii) utilize the audio signal as input to one or more beat estimation modules to determine beat timestamp data indicating timestamps of beats and/or downbeats for the audio signal, (iii) generate beat metadata for the audio signal based on the beat timestamp data, (iv) receive user input directed to causing playback of the audio signal, (v) receive additional user input directed to configuring the system to cause presentation of beat and/or downbeat cues during playback of the audio signal, (vi) cause playback of the audio signal, and (vii) use the beat metadata to cause presentation of the beat and/or downbeat cues during the playback of the audio signal, wherein the beat and/or downbeat cues are caused to be presented in accordance with the timestamps of the beats and/or downbeats for the audio signal represented in the beat metadata.

### CROSS-REFERENCE TO RELATED APPLICATIONS

This application claims priority to U.S. Provisional Patent Application No. 63/504,951, filed on May 30, 2023, and entitled “BEAT AND DOWNBEAT ESTIMATION AND PLAYBACK”, the entirety of which is incorporated herein by reference for all purposes.

### BACKGROUND

A metronome is a timekeeping device that musicians use to help hone their musical skills. This “timekeeping” is normally achieved by a generation of periodic audible clicks (representing beats) or visual cues at a specified tempo (or rate). The periodicity of these audible clicks or visual cues enables musicians to maintain a consistent rhythmic pattern while playing their instruments. Additionally, metronomes can aid musicians in (i) developing a strong sense of timing, (ii) improving their technical skills, and (iii) perfecting their performance. Further, metronomes can promote an understanding of the underlying rhythmic structures within a piece of music, for example, by helping musicians play notes that fall between the clicks at an even rate or by instilling a sense of rhythm for when no metronome is being used. Such skills are vital components of musical education and professional performance.

Musical beats are regularly separated into different types for learning purposes, such as downbeats and regular beats. Downbeats are generally the first beat in a measure and are usually emphasized in the music. Regular beats are the beats other than downbeats.

In recent years, the analysis of computer audio files has become widespread. Computer programs designed to process audio files (e.g., MP3 files) have become widely used tools in automatically analyzing and estimating beat locations and the rate of the beats (beats per minute or BPM). This is commonly done using a BPM analyzer or a digital audio workstation (DAW). The beats of a song may be estimated and used to help DJs, music producers, sound engineers, etc., to synchronize, mix, and/or arrange tracks. For example, a DJ may use a BPM analyzer to mix two tracks together by aligning the beats of the two tracks.

In live performances, musicians frequently shape the rhythm by slowing down (e.g., “ritardando,” “ritenuto,” or “lentando”) or speeding up (e.g., “accelerando,” “affrettando,” or “stringendo”) in large or small amounts during their performance. The musical term “rubato”—the free adjustment of rhythm/tempo at a musician's discretion—can refer to the naturally, and often beautifully, improvised rhythmic structures that one may hear at live performances or when listening to recordings of live performances.

However, such variations in tempo can present problems for beat estimation techniques, which output a static BPM value (i.e., a BPM value that remains even and constant throughout a section (or sections) of music). Static BPM values can fail to capture the true rhythm of a performance, in particular where the performance included variations in tempo. As a result, a metronome set to a static BPM value can become offbeat with respect to a live recording of a song in which tempo variations were utilized. An offbeat metronome, during any part of a performance, can cause user frustration.

The subject matter claimed herein is not limited to embodiments that solve any challenges or that operate only in environments such as those described above. Rather, this background is only provided to illustrate one exemplary technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example user interface for facilitating selection of audio content for processing.

FIG. 2 illustrates an example user interface for controlling playback of selected audio content.

FIGS. 3 and 4 illustrate example user interfaces for facilitating presentation of beat cues and/or downbeat cues based on beat metadata for selected audio content.

FIGS. 5, 6, 7, and 8 illustrate example flow diagrams depicting acts associated with facilitating beat and/or downbeat estimation and/or playback.

FIG. 9 depicts example components of a system that may comprise or be configurable to perform various embodiments.

### DETAILED DESCRIPTION

As noted above, conventional metronomes fail to capture the true rhythmic structure (or beat) of many musical recordings, especially recordings of live musical events. For instance, conventional metronomes fail to adapt to tempo variations or shifts in rhythmic emphasis that commonly occur in live music or recordings. This can create a disconnect between a metronome's static tempo and the natural fluctuations in a song's rhythm.

One conventional approach to capturing a song's rhythmic structure involves using computer software to estimate the rate at which beats occur (beats per minute (BPM)). This can be done using a BPM analyzer. However, conventional BPM analyzers only output static BPM values (i.e., an even and consistent rhythmic structure) associated with the overall tempo of an entire musical recording or section of music.

While conventional BPM analysis techniques may work in circumstances where the rhythmic structure of a song is indeed static, static BPM values output under conventional techniques can be disjointed from recordings where the recorded musicians improvise the rhythm. The imprecision with which conventional metronomes present beat cues (audible, visual, or tactile cues) in these situations can pose a problem to, for example, musicians attempting to practice using these recordings and/or to DJs mixing tracks. Accordingly, there exists a need for systems, methods, and techniques for dynamically presenting beat cues corresponding to the improvisational rhythms inherent in the styles of many musicians.

At least some disclosed embodiments can enable users to select any audio content (also referred to as an audio signal) for processing. For example, a user may select a recording file from a library of recording files, upload a locally stored recording file, or select an audio stream on which dynamic beat estimation is to be performed. The selected audio content may then be processed, either locally or via cloud-based resources, to determine the estimated location of each beat and/or downbeat of the audio content. If the rhythm changes dynamically throughout the audio content, at least some disclosed processes will likewise adapt the estimated locations of each beat and/or downbeat to properly represent the rhythm of the audio content. In at least some implementations, an advanced audio processing method is used to detect and adapt to tempo variations in real-time, allowing musicians to develop their skills in a manner that closely resembles real-world performance scenarios. Metadata associated with the estimated locations of the beats and/or downbeats may be created to facilitate later presentation of the estimated locations to users.

In some instances, utilizing metadata (indicating timestamps of beats and/or downbeats) to facilitate metronome playback can reduce data transfer requirements between a server and a playback device and/or can reduce computational requirements associated with beat and/or downbeat estimation (e.g., relative to generating a separate metronome file configured for simultaneous playback with an underlying audio file).

After reading the above-mentioned metadata, the estimated locations of the beats and/or downbeats for the audio content may then be presented to the user via a user interface (e.g., for visual, audible, or tactile reception by the user). In at least some embodiments, this presentation is done using beat cues, which are typically either visual representations or audible “clicks.” The presentation of beat cues, however, is not limited to just audible/visual representations. Neither is the presentation limited to any specific audible or visual cue. For example, the audible cues may be customized by users to fit their preferences; in other words, other types of audible sounds aside from “clicks” may be utilized in accordance with implementations of the present disclosure. Likewise, visual cues need not fit any specific visual format, but may be customized to fit the preferences of the user.

In some implementations, the user may further subdivide the rhythm of the audio content. For example, if the audio content presented a song in a 4/4 time signature, the user could further divide the time signature into an 8/8 time signature. This subdivision allows for more beat cues to be presented interleaved with the original 4/4 time signature. Subdividing the time signature of a song can further allow a musician to practice the rhythm of beats that fall between the original beat cues. The beat cues, regardless of whether they are further subdivided, may still be presented dynamically according to the audio content (e.g., with temporal variations that correspond to the rhythmic variations present in the underlying audio content).

Additionally, disclosed embodiments may be configured to distinguish between beats and downbeats throughout a beat location estimation process. Such functionality can enable beats and downbeats to be distinguished from one another during playback (e.g., by triggering different sounds and/or visual cues for beats vs downbeats).

The functionality described herein related to estimating beat locations and/or modification may be provided using any suitable processing component(s) (e.g., local and/or remote/cloud resources) and may be accessible using any suitable user interface(s) (e.g., via an application and/or website accessible via a mobile electronic device such as a smartphone or tablet, a desktop or laptop computer, a wearable device, etc.).

Although at least some examples discussed herein focus, in at least some respects, on detecting and/or distinguish beats and downbeats, the disclosed principles may be applied to facilitate detection and/or distinction of different types of beats (e.g., upbeats, offbeats, and/or others).

Having just described some of the various high-level features and benefits of the disclosed embodiments, attention will now be directed to the Figures, which illustrate various conceptual representations, architectures, methods, and/or supporting illustrations related to the disclosed embodiments.

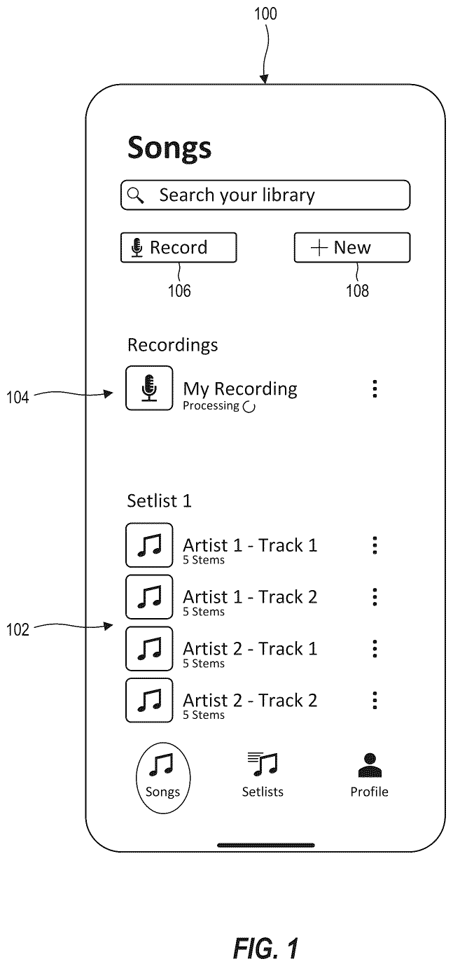

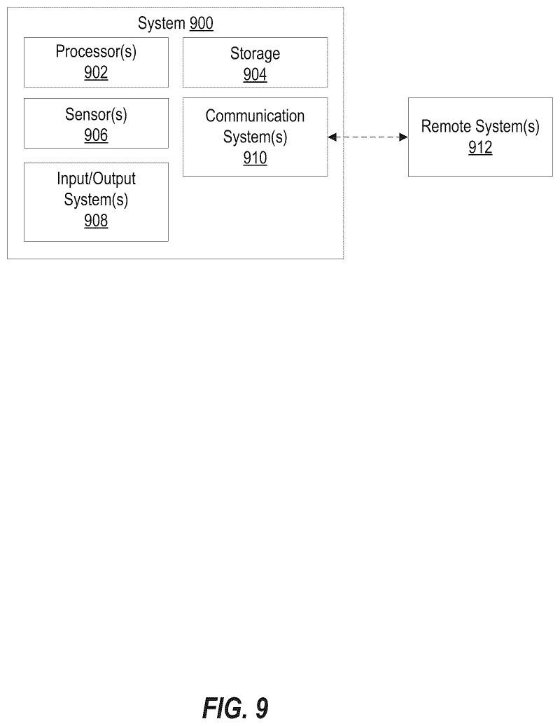

FIG. 1 illustrates an example user interface 100 for facilitating selection of audio content for processing. One or more aspects of the user interface 100 (and other user interfaces described herein) can be presented on various types of devices or systems, such as smartphones, tablets, laptop computers, desktop computers, wearable devices, and/or other devices (e.g., which devices or systems can correspond to or include components of system 900, described hereinafter with reference to FIG. 9). The user interface 100 can be presented on a user device in association with operation of a downloaded and/or web-based (e.g., server- or cloud-based) application (e.g., a music software application).

In the example shown in FIG. 1, the user interface 100 provides access to various audio content (e.g., audio signals) in the form of audio tracks 102 and audio recordings 104. The audio content may comprise one or more locally and/or remotely stored audio or recording files. In some instances, selected audio content may comprise an audio stream (e.g., provided by a web streaming service, radio-based service, satellite service, line-in connection, etc.). In some implementations audio content may be added to the audio tracks 102 and/or the audio recordings 104 displayed in the user interface 100 via one or more user actions. For example, the user interface 100 includes a record button 106 and an add button 108. The record button 106 may be selectable via user input to facilitate recording of an audio file for inclusion with the audio recordings 104. Similarly, the add button 108 may be selectable via user input to facilitate selection of additional audio files/tracks (e.g., from a local or remote repository, or by selecting one or more music streaming or radio or other audio services) for inclusion with the audio tracks 102.

In some instances, the audio content represented in a user interface 100 includes one or more audio stems. For example, each of the audio tracks 102 are displayed in conjunction with an indicator of the quantity of audio stems (e.g., “5 Stems”) associated with the respective audio track. Audio stems can refer to the component parts of a complete musical track, such as vocals, drums, bass, guitar, keys/piano, and/or other sources of audio.

In the example shown in FIG. 1, the audio recordings 104 includes a newly recorded file referred to herein as “My Recording”. My Recording may have been recorded after selection of the record button 106 of the user interface 100. The user interface 100 of FIG. 1 conceptually depicts processing of the My Recording file with the “Processing” label proximate to the My Recording label. The processing of audio content as indicated in FIG. 1 can comprise performing stem separation (e.g., to isolate individual audio stems represented in the audio content from one another). The processing of the audio content can additionally or alternatively include estimating the locations of beats and/or downbeats for the selected audio content. For instance, after selection of audio content shown in the user interface 100 (or after selection of audio content to add to the user interface 100), the audio content may be processed (e.g., via local computing resources, such as those of a client device/system, and/or via remote resources, such as cloud or server resources) to determine the estimated locations of beats and/or downbeats for the selected audio content. The estimated locations of the beats and/or downbeats of the selected audio content can be represented as a data object, file, or structure in which the timestamps of the detected beats and/or downbeats (along the timeline of the selected audio content) are recorded or logged. In some implementations, the data object, file, or structure that indicates the timestamps of the beats and/or downbeats provides a basis for, or is used to generate, metadata that can be associated with the selected audio content (e.g., via embedding, packaging, attaching, indexing, coupling, inclusion in a metadata directory, pairing or key-value pairing, or other techniques). Metadata generated and associated with audio content based on estimated beat and/or downbeat timestamps for the audio content is referred to herein as “beat metadata” or “beat/downbeat metadata”.

In some implementations, the beat metadata (or beat timestamp data on which the beat metadata is based) is generated at a client device by processing audio content using one or more beat estimation modules at the audio device. The client device may then use the beat metadata to cause presentation of beat and/or downbeat cues during playback of the audio content. In some instances, the beat metadata (or beat timestamp data) is generated by a remote device (e.g., a server) and sent to and received by a client device for the client device to use to facilitate presentation of beat and/or downbeat cues during playback of the audio content. In some instances, the beat metadata (or beat timestamp data) is generated at a server or other remote device that supports a web application or other interface that is accessible to client devices to facilitate presentation of beat and/or downbeat cues during playback of the audio content.

Various types of processing modules may process input audio content/signals to estimate beat and/or downbeat locations for the input audio content/signals, such as processing modules that utilize music information retrieval (MIR) techniques, machine learning techniques, and/or other. In some instances, one or more processing modules for estimating beat and/or downbeat locations (also referred to herein as “beat estimation modules”) utilize a combination of Fourier transformations, neural networks, and probabilistic modeling may be used to output the beats and/or downbeats of a song. Additional details related to an example beat estimation process for estimating the locations of beats and/or downbeats associated with audio content will now be provided. Advantageously, processing modules for determining beat and/or downbeat locations (or beat timestamps) can be configured to account for variations in tempo in the input audio content/signal, such that the output beat and/or downbeat locations (or beat timestamps) can include irregularities that correspond to the tempo variations in the input audio content/signal.

A first act of the example beat estimation process includes computing a spectrogram of an audio signal x using a discrete Fourier transform (other transformation methods may be used). In the present example, the spectrogram is denoted as matrix S. The first act can further include applying a Hann window (or another type of window) to snippets N=2048 samples (or another quantity) with a hop size of H=441 (or another hop size). The first act can further include applying a filterbank F of triangular filters (or any type of filter) centered at the semitone frequencies of the chromatic scale (or centered at other frequencies) and taking the logarithm of a linear transformation with scale γ=1 (or another scale factor) and shift α=1×10\hat{ }(−6) (or another value) of the spectrogram to compute L(f), which may be denoted by:

$${S}_{t , f} = {\sum }_{n = 0}^{N - 1} x [ n + tH ] \cdot w [ n ] \cdot {e}^{- j \cdot 2 \frac{π \cdot f \cdot n}{N}}$$

$$L = log ( γ ⊙ \vert S \vert \cdot F + α )$$

A second act of the example beat estimation process can include passing this representation (e.g., L(f)) through a deep convolutional neural network, denoted as f (other types of neural networks and/or machine learning modules may be utilized). The neural network may be trained on a large set of audio tracks with human-annotated beat and downbeat positions. The second act can further include computing the beat and downbeat activations A. These activations can indicate the presence and/or absence of beats and downbeats for every time frame in the audio recording. The second act may be denoted by:

$$A = f ( L )$$

The formulas underlying f may depend on the architecture of the neural network. In one example implementation, the formulas of f use a convolution front-end with three stacks of convolution and max-pooling layers followed by a temporal convolution network with four layers, each with different dilation sizes. As noted above, other model types, architectures, hyperparameters, etc. may be utilized.

A third act of the example beat estimation process can include processing the activations through a dynamic Bayesian network (DBN) (or other type of network) that encodes musical information about the progression of downbeats and beats for multiple musical meters (e.g., 3/4 or 4/4 time signatures, or others). Each state of the DBN can correspond to a position within a musical bar. The third act can further include using the Viterbi algorithm (or other type of module) to find the state sequence with the highest probability (denoted as ŷ) given the beat and downbeat activations, denoted by:

$$\hat{y} = arg {max}_{y} P ( y \vert A )$$

A fourth act of the example beat estimation process can include selecting the elements in ŷ that correspond to beats or downbeats and computing their corresponding estimated location (e.g., temporal location or timestamp) in time by dividing their index in ŷ through the hop size H (discussed above with reference to the first act). The output of the fourth act may comprise the beat and/or downbeat timestamp data noted above (also referred to herein as “beat/downbeat timestamp data” or simply “beat timestamp data”). Advantageously, timestamp data obtained by the example beat estimation process noted above (or similar processes) may capture variations in tempo where such variations are present in the input audio content/signal. In some implementations, beat and/or downbeat timestamp data may be determined/estimated for individual stems/components of the selected audio content and may be used to generate beat/downbeat metadata for association with the individual stems/components of the selected audio content.

One will appreciate, in view of the present disclosure, that the particular aspects of the acts for estimating beats and/or downbeats described hereinabove may be varied without departing from the principles of the present disclosure, and that additional or alternative steps/operations may be utilized.

Other MIR techniques that may be utilized to facilitate beat and/or downbeat estimation may include specific onset detection models, probabilistic models, and machine learning techniques.

Onset detection focuses on identifying the beginnings of musical events, such as note attacks or percussive hits. Various methods, including energy-based, spectral-based, and phase-based approaches, can be employed to detect onset in the audio signal. Once onsets are detected, they can be used to estimate the beats and downbeat positions.

Probabilistic models, such as Hidden Markov Models (HMMs) or Dynamic Bayesian Networks (DBNs), can be used to model the temporal dependencies between beats and downbeats. These models can predict the most likely positions of beats and downbeats in a given audio signal by incorporating prior knowledge about musical structure and rhythmic patterns.

Machine learning techniques, including deep learning models like convolutional neural networks (CNNs) and recurrent neural networks (RNNs), can be trained on large datasets to automatically learn the features and patterns that are relevant for beat and downbeat detection. Once trained, these models can generalize to new, unseen music data, providing robust and accurate estimates of beat and downbeat temporal locations or timestamps.

In the example shown in FIG. 1, the “processing” of the My Recording audio content comprises using the My Recording audio content as input to one or more beat estimation modules that provide beat timestamp data based on the input audio content. The beat timestamp data can include the timestamps of beats and/or downbeats of the My Recording audio file, which may account for variations in tempo. The beat timestamp data is used to generate beat metadata for the My Recording audio file, which becomes associated with the My Recording audio file and can be used to facilitate the presentation of beat and/or downbeat cues during playback of the My Recording audio content.

After processing of audio content as described above (e.g., to achieve stem separation, beat/downbeat estimation, etc.), the audio content may be accessed and/or interacted with in various ways. For instance, the audio tracks 102 as represented in the user interface 100 may have already been processed to determine separated stems and/or beat/downbeat metadata, and the audio tracks 102 may be selectable within the user interface 100 for further interaction with the audio content underlying the audio tracks 102 and/or with artifacts/outputs resulting from processing of the audio tracks 102. Similarly, after completion of the processing of the My Recordings file as conceptually depicted in FIG. 1 (or before initiation or completion of the processing), the My Recordings file may be selected within the user interface 100 for further interaction with its associated content (and/or outputs from the processing, such as separated stems and/or estimated beats/downbeats).

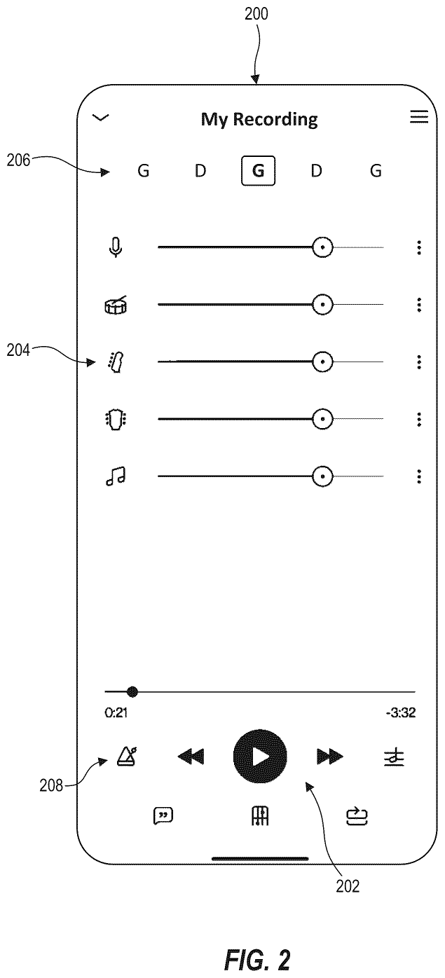

FIG. 2 illustrates an example user interface 200 that includes various elements for interacting with audio content and/or processing outputs associated with selected audio content. For instance, user interface 200 can be presented on a user device after selection of the My Recording file of the user interface 100 discussed hereinabove with reference to FIG. 1. The user interface 200 of FIG. 2 includes playback controls 202, which include play/pause elements, fast-forward and rewind (or skip) elements, and a navigation bar (e.g., indicating playback progress and facilitating scrubbing/navigating through the selected audio content). The user interface 200 of FIG. 2 further includes a stem control region 204, which includes icons associated with various audio stems represented in the My Recording audio content (e.g., vocals at the top, followed in descending order by drums, bass, guitar, and remaining audio). The stem control region 204 also includes volume control sliders for adjusting the volume of individual audio stems of the My Recording content, which can enable removal, emphasis, de-emphasis, isolation, and/or other adjustments to individual audio stems during playback. The user interface 200 of FIG. 2 furthermore includes a chord indicator region 206, which can display chords associated with the portion of the audio content currently being played back (or currently queued for playback, such as when playback is paused). The chords of the audio content can be determined during the processing discussed hereinabove.

The example user interface 200 shown in FIG. 2 furthermore includes a metronome element 208, which can comprise a selectable element for facilitating presentation of beat cues and/or downbeat cues based on the beat metadata for the applicable/selected audio content (e.g., the My Recording audio file, and/or stems or combinations of stems thereof).

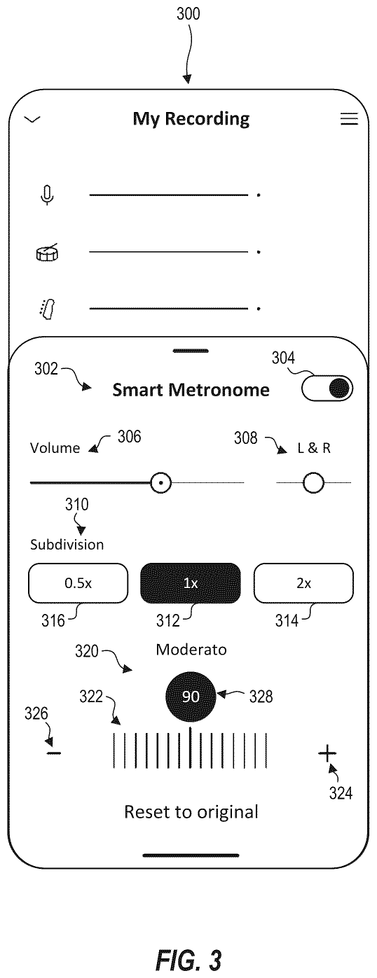

FIG. 3 illustrates an example user interface 300 for facilitating presentation of beat cues and/or downbeat cues based on beat metadata for the selected audio content. For instance, the example user interface 300 includes a metronome region 302, which can be presented after selection of the metronome element 208 discussed hereinabove with reference to FIG. 2. The metronome region 302 can display various elements enabling presentation of beat and/or downbeat cues during playback of the My Recording audio file (and/or stems or combinations of stems thereof).

In the example shown in FIG. 3, the metronome region 302 includes a metronome toggle 304 to which user input (e.g., touch or other input) can be directed for activating or deactivating a metronome playback mode. FIG. 3 illustrates the metronome toggle 304 in a state that indicates that the metronome playback mode is active. In some embodiments, when the metronome playback mode is active, the system presenting the user interface 300 (e.g., a user device or system 900) causes presentation of beat and/or downbeat cues during playback of the selected audio content (e.g., the My Recording audio file, the playback of which may be triggered by interaction with the playback controls 202. In contrast, when the metronome playback mode is inactive, the system presenting the user interface 300 can refrain from causing presentation of beat and/or downbeat cues during playback of the selected audio content.

The metronome region 302 may be surfaced and/or the metronome toggle 304 may be switched any time before or during playback of the selected audio content. For instance, a user interacting with the user interface 200 may direct user input to the playback controls 202 to initiate playback of the My Recording audio file, after which the user may direct user input to the metronome element 208, causing the metronome region 302 to be surfaced during playback of the My Recording audio file. The user may then direct user input to the metronome toggle 304 to activate the metronome playback mode and to cause beat and/or downbeat cues to be presented during the playback of the My Recording audio file. As another example, a user may first direct user input to the metronome toggle 304 to activate the metronome playback mode and subsequently initiate playback of the My Recording file (or any audio content). Along these lines, the user may interact with the metronome toggle 304 to deactivate the metronome playback mode at any desired time. In some instances, the metronome playback mode is in an active state by default (or based on user-defined preferences).

The beat and/or downbeat cues caused to be presented by a system (e.g., the system presenting the user interface 300 while the metronome mode is active) can take on various forms. For example, the beat and/or downbeat cues can comprise audible cues or sounds (e.g., clicks, taps, beeps, bells, chimes, digital tones, etc.), visual cues (flashing lights, swinging pendulums, digital display, color changes), tactile cues (e.g., pulses or vibrations), and/or others. In some implementations, the system presenting the user interface 300 can cause presentation of the beat and/or downbeat cues using on-device hardware (e.g., speakers, displays, vibration motors, etc.) and/or by communication with external or connected hardware (e.g., via a wired or wireless connection with one or more speakers, displays, vibration motors, etc.).

In the example shown in FIG. 3, the system presenting the user interface 300 uses the beat metadata generated for the selected audio content (e.g., the My Recording audio file) to cause presentation of the beat and/or downbeat cues during playback of the selected audio content. For example, the system may read the timestamps of the beats and/or downbeats from the beat metadata and, when the temporal progression of the playback of the selected audio content reaches a beat or downbeat timestamp recorded in the audio file, the system may trigger a beat or downbeat cue. By reading the metadata to facilitate presentation of beat and/or downbeat cues, systems may avoid generating, storing, or transmitting entire metronome audio tracks that includes metronome sounds for each piece of audio content to achieve metronome playback functionality. Instead, beat metadata may be stored and/or transmitted along with its corresponding piece of audio content, which can reduce storage requirements and/or increase efficiency.

In some implementations, different types of metronomic cues are used during playback of audio content with the metronome playback mode active. For example, a downbeat cue may be presented for downbeats, whereas beat cues that are different from downbeat cues may be presented for other beats. In some instances, the beat metadata for selected audio content includes both beat timestamps and downbeat timestamps, which may be differentiated by labels or other means. In the example shown in FIG. 3, where beat and downbeat timestamps are differentiated in the beat metadata for the My Recording audio content, the system may cause presentation of a downbeat cue when playback of the audio content temporally progresses to a downbeat timestamp, and the system may cause presentation of a beat cue when playback of the audio content temporally progresses to a beat timestamp (or non-downbeat timestamp). Such functionality can enable users to easily differentiate beats from downbeats during playback of audio content with the metronome playback mode active.

In addition, or as an alternative, to differentiating beat timestamps from downbeat timestamps in beat metadata for audio content, a system may be configured to utilize a known time signature for audio content and/or pickup measure information to facilitate presentation of different cues for beats and downbeats during playback of audio content with the metronome playback mode active. Such time signature, pickup measure, and/or other information may be included in metadata for audio content to enable such functionality and may be determined by processing modules (e.g., the beat estimation module(s)), entered via user input, etc.

As shown in FIG. 3, the metronome region 302 of the user interface 300 includes other interactive elements for controlling features associated with the metronome playback mode. For instance, the metronome region 302 includes a volume control element 306 for adjusting the volume of the beat and/or downbeat cues, as well as a balance element 308 for adjusting the distribution of sound between left and right channels.

The metronome region 302 further includes a subdivision region 310 for controlling the subdivision of beat cues presented when the metronome playback mode is active. The subdivision region 310 includes an undivided selectable element 312 (labeled as “1×”) that, when selected, can cause beat and/or downbeat cues to be presented during playback for each beat and/or downbeat represented in the beat metadata for the selected audio content (e.g., the My Recording audio content). The subdivision region 310 also includes an increase subdivision selectable element 314 (labeled as “2×”) that can cause an increase in beat subdivision when selected (e.g., via user input directed thereto). In the example shown in FIG. 3, when the increase subdivision selectable element 314 is selected, subdivided beat cues can be caused to be presented in addition to the beat and/or downbeat cues associated with the beat metadata. For instance, where the beat and/or downbeat timestamps for the selected audio content (e.g., My Recording) represent or approach quarter beats (e.g., for 4/4, 3/4, or 2/4 time signature), the system may cause presentation of subdivided beat cues representing duplet beats, triplet beats, quadruplet beats, quintuplet beats, sextuplet beats, septuplet beats, octuplet beats, and/or beat cues for other types of beat subdivisions in addition to the beat and/or downbeat cues.

The subdivision region 310 also includes a decrease subdivision selectable element 316 (labeled as “0.5×”) that can cause a decrease in beat subdivision when selected (e.g., via user input directed thereto). In the example shown in FIG. 3, when the decrease subdivision selectable element 316 is selected, the system can selectively refrain from causing presentations of beat and/or downbeat cues for at least some of the beat and/or downbeat timestamps represented in the beat metadata for the selected audio content. For instance, where the beat and/or downbeat timestamps for the selected audio content (e.g., My Recording) represent or approach quarter beats (e.g., for 4/4, 3/4, or 2/4 time signature), the system may skip presentation of every other beat presentation to allow each beat cue to represent a half beat. Other subdivision decreases are within the scope of the present disclosure.

The user interface 300 illustrated in FIG. 3 also includes a speed changing region 320, which can indicate the tempo at which the selected audio content is determined to be played (such information can be determined via the processing of the audio content described hereinabove with reference to FIG. 1). The speed changing region 320 can include interactable elements (e.g., a navigation bar 322, an increase element 324, a decrease element 326) to facilitate selection of a playback tempo for the audio content. The playback tempo can comprise the tempo at which the audio content is intended to be perceived as being played at during playback of the audio content. The playback tempo can be indicated in the speed changing region 320 by an indicator 328.

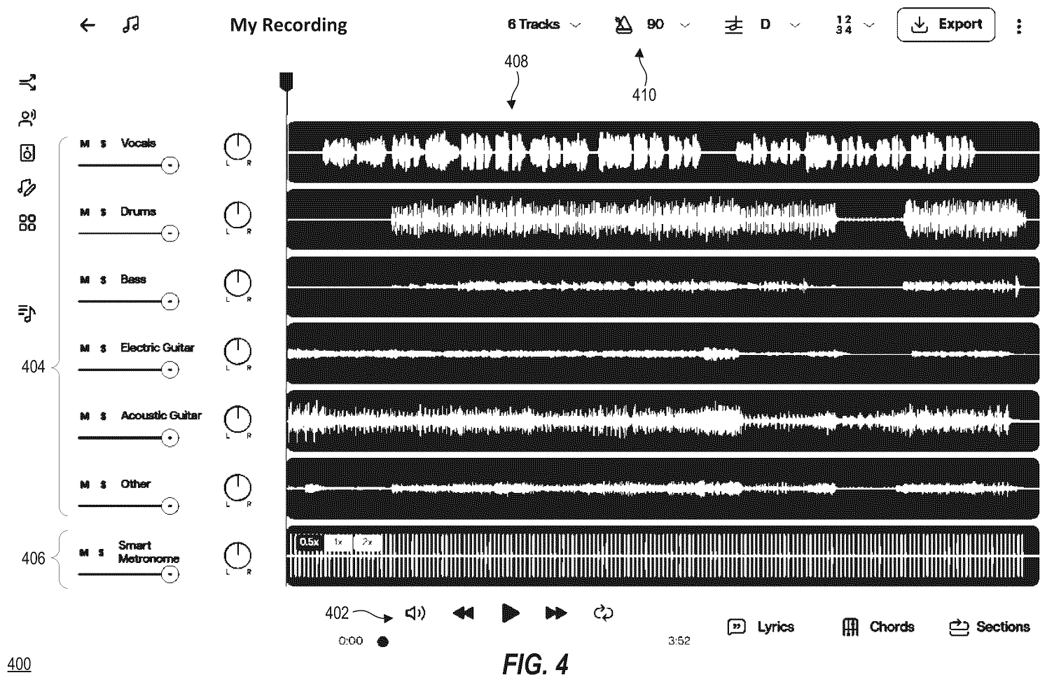

One will appreciate, in view of the present disclosure, that the particular interactable elements for activating/deactivating and controlling the presentation of beat and/or downbeat cues shown and described with reference to FIG. 3 are provided by way of illustrative, non-limiting example only. The principles and functionality described hereinabove with reference to FIGS. 1 through 3 may be achieved with other implementation characteristics. By way of further example, FIG. 4 illustrates another user interface 400 for facilitating presentation of beat cues and/or downbeat cues based on beat metadata for the selected audio content. The user interface 400 can be presented via a web application accessible via a web browser on any suitable device. Similar to the user interface 200 and/or the user interface 300, the user interface 400 includes playback controls 402, a stem control region 404, and a metronome region 406 (labeled “Smart Metronome”). Each of the stems represented in the stem control region 404 (labeled “vocals”, “drums”, “bass”, “electric guitar”, “acoustic guitar”, “other”) and the metronome region 406 include a respective volume control element (under its respective label) and a respective balance element (adjacent to its respective label, denoted by “L” and “R” icons adjacent to a round adjustment feature). Each of the stems and the metronome region also include a mute feature (labeled “M”) and an isolate feature (labeled “S”). The metronome region 406 also includes a subdivision region (denoted by selectable elements labeled “0.5×”, “1×”, and “2×”). The user interface 400 includes waveform representations 408 of each stem of the stem control region 404 and the metronome region 406. In some instances, the waveform representation for the metronome region 406 is generated based on the beat metadata for the selected audio content (e.g., the My Recording audio file/signal). The user interface 400 also includes a speed changing element 410 that can be used to modify the playback tempo of the selected audio content. Other formats for presenting user interface displays and/or other features/components related to beat and downbeat estimation and playback may be used within the scope of the present disclosure.

The following discussion now refers to a number of methods and method acts that may be performed in accordance with the present disclosure. Although the method acts are discussed in a certain order and illustrated in a flow chart as occurring in a particular order, no particular ordering is required unless specifically stated, or required because an act is dependent on another act being completed prior to the act being performed. One will appreciate that certain embodiments of the present disclosure may omit one or more of the acts described herein.

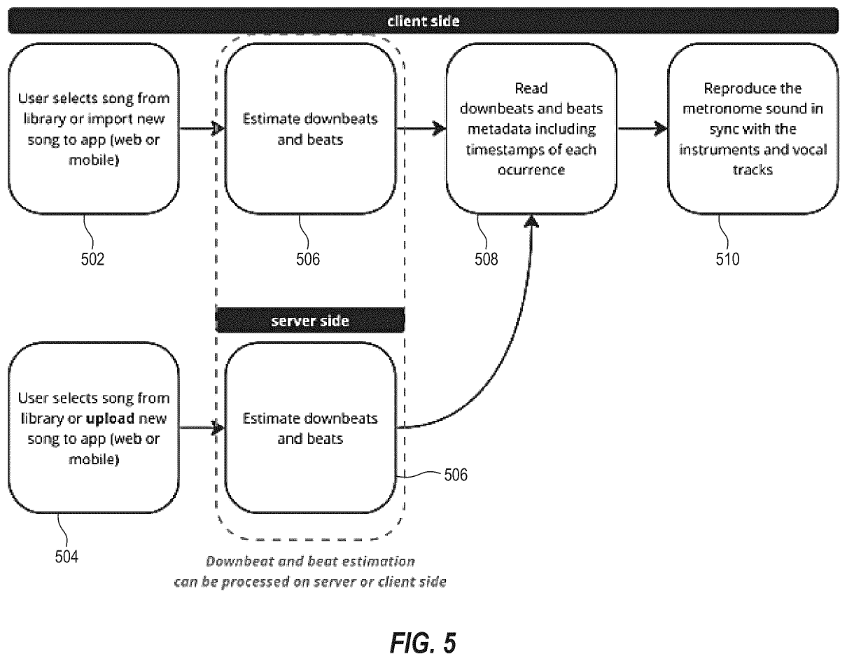

FIG. 5 illustrates an example flow diagram depicting acts associated with facilitating beat and downbeat estimation and/or presentation. Downbeat estimation and/or presentation may be accomplished by accessing an audio signal, estimating the location of beats and/or downbeats associated with the audio signal, generating metadata indicating the estimated locations, and/or outputting beat cues and/or downbeat cues based upon the metadata.

FIG. 5 conceptually depicts accessing of an audio signal. In the example of FIG. 5, step 502 represents when a user selects audio content (e.g., a song) from a digital library and/or imports the audio content to be processed via an application (app). The app may be web based (e.g., accessible via an internet browser) and/or mobile based (e.g., via a mobile device application). In step 502, the audio content remains on the client side via the importation of the audio content directly to the app. In contrast, step 504 describes a user uploading selected audio content to a server-side app (e.g., web based or mobile based).

FIG. 5 also conceptually depicts estimating beat and/or downbeat locations (e.g., temporal locations relative to the audio signal being processed). In step 506, the audio content is then processed to estimate the downbeats and/or beats of the audio signal accessed in accordance with steps 502 and/or 504. FIG. 5 depicts step 506 as being performable on a client device (“client side”) or on a server (“server side”). In some implementations, the audio content undergoes the same processing regardless of being on the client side or the server side. Step 506 may be performable via one or more beat estimation modules as described hereinabove.

Step 508 of FIG. 5 includes reading the metadata created from step 506 (e.g., using one or more components of a system 900). This metadata may include timestamps (e.g., estimated temporal locations) of each beat and/or downbeat occurrence. Afterwards, in step 510, the reproduction of beats and/or downbeats may be presented as described above (e.g., visually, audible, and/or tactilely). By using the metadata (read in accordance with step 508), the reproduction of the beats can be presented in sync with playback of the audio signal to provide beat/downbeat cue playback that accurately follows the rhythmic structure of the audio signal. Step 510 can further include representing beat cues and downbeat cues with different presentations, such as by providing one type of output for beat cues and another type of output for downbeat cues.

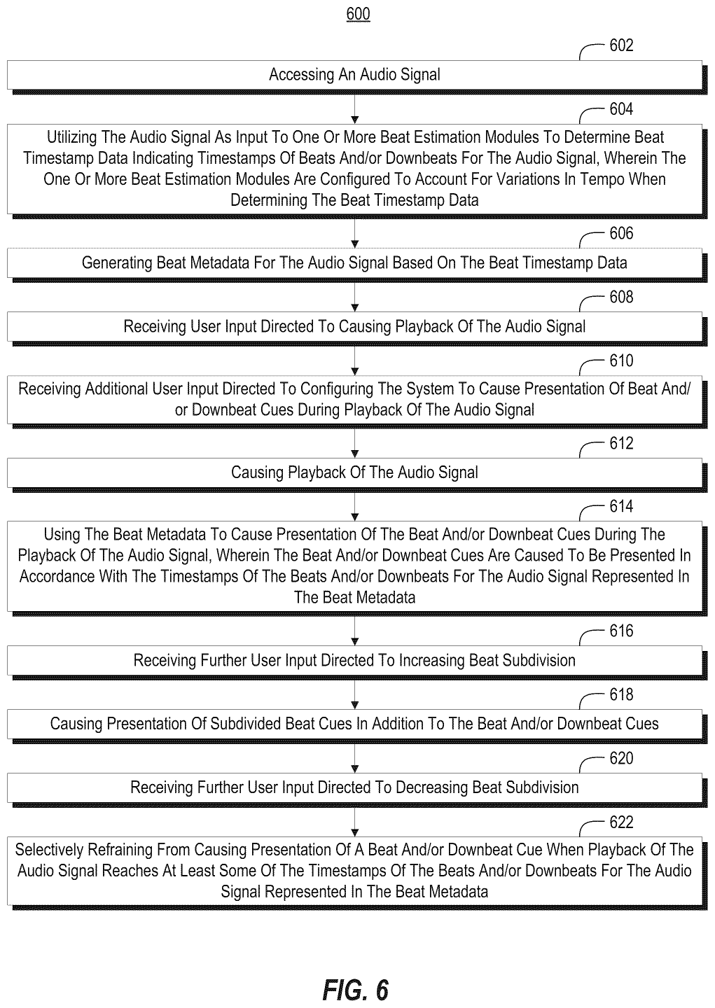

FIGS. 6, 7, and 8 illustrate example flow diagrams 600, 700, and 800, respectively, depicting acts associated with facilitating beat and downbeat estimation and/or playback. The acts described with reference to FIGS. 6, 7, and 8 can be performed using one or more components of one or more systems 900 described hereinafter with reference to FIG. 9, such as processor(s) 902, storage 904, sensor(s) 906, I/O system(s) 908, communication system(s) 910, remote system(s) 912, etc.

Act 602 of flow diagram 600 of FIG. 6 includes accessing an audio signal. In some instances, the audio signal comprises an audio recording of a song. In some implementations, the audio signal comprises an audio stem separated from an audio recording of a song.

Act 604 of flow diagram 600 includes utilizing the audio signal as input to one or more beat estimation modules to determine beat timestamp data indicating timestamps of beats and/or downbeats for the audio signal, wherein the one or more beat estimation modules are configured to account for variations in tempo when determining the beat timestamp data. In some examples, the one or more beat estimation modules utilize a combination of Fourier transforms, neural networks, and probabilistic models to determine the beat timestamp data.

Act 606 of flow diagram 600 includes generating beat metadata for the audio signal based on the beat timestamp data.

Act 608 of flow diagram 600 includes receiving user input directed to causing playback of the audio signal.

Act 610 of flow diagram 600 includes receiving additional user input directed to configuring the system to cause presentation of beat and/or downbeat cues during playback of the audio signal. In some instances, the additional user input directed to configuring the system to cause presentation of beat and/or downbeat cues during playback of the audio signal comprises user input activating a metronome playback mode. In some implementations, the beat and/or downbeat cues comprise audible cues or visual cues.

Act 612 of flow diagram 600 includes causing playback of the audio signal.

Act 614 of flow diagram 600 includes using the beat metadata to cause presentation of the beat and/or downbeat cues during the playback of the audio signal, wherein the beat and/or downbeat cues are caused to be presented in accordance with the timestamps of the beats and/or downbeats for the audio signal represented in the beat metadata. In some examples, using the beat metadata to cause presentation of the beat and/or downbeat cues during playback of the audio signal comprises: (i) reading the timestamps of the beats and/or downbeats for the audio signal represented in the beat metadata, and (ii) when playback of the audio signal reaches one of the timestamps of the beats and/or downbeats for the audio signal represented in the beat metadata, causing presentation of a beat and/or downbeat cue. In some instances, the timestamps of the beats and/or downbeats for the audio signal represented in the beat metadata comprise beat timestamps and downbeat timestamps. In some implementations, a beat cue is caused to be presented when playback of the audio signal reaches one of the beat timestamps, and a downbeat cue is caused to be presented when playback of the audio signal reaches one of the downbeat timestamps. The downbeat cue can be different from the beat cue.

Act 616 of flow diagram 600 includes receiving further user input directed to increasing beat subdivision.

Act 618 of flow diagram 600 includes causing presentation of subdivided beat cues in addition to the beat and/or downbeat cues.

Act 620 of flow diagram 600 includes receiving further user input directed to decreasing beat subdivision.

Act 622 of flow diagram 600 includes selectively refraining from causing presentation of a beat and/or downbeat cue when playback of the audio signal reaches at least some of the timestamps of the beats and/or downbeats for the audio signal represented in the beat metadata.

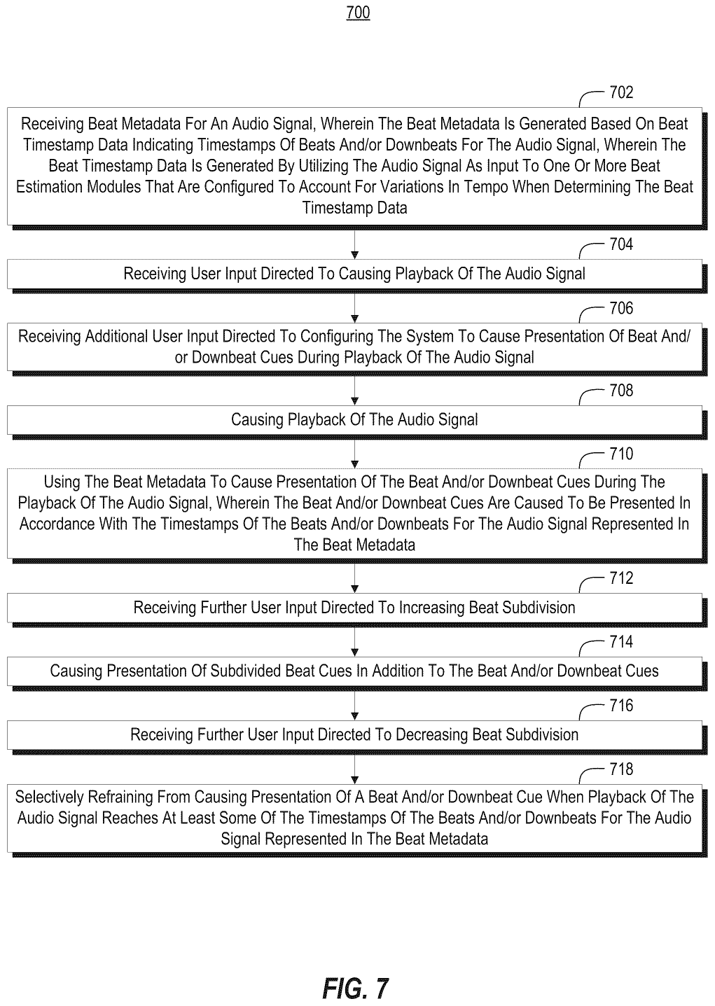

Act 702 of flow diagram 700 of FIG. 7 includes receiving beat metadata for an audio signal, wherein the beat metadata is generated based on beat timestamp data indicating timestamps of beats and/or downbeats for the audio signal, wherein the beat timestamp data is generated by utilizing the audio signal as input to one or more beat estimation modules that are configured to account for variations in tempo when determining the beat timestamp data. In some instances, the audio signal comprises an audio recording of a song. In some implementations, the audio signal comprises an audio stem separated from an audio recording of a song. In some examples, the one or more beat estimation modules utilize a combination of Fourier transforms, neural networks, and probabilistic models to determine the beat timestamp data.

Act 704 of flow diagram 700 includes receiving user input directed to causing playback of the audio signal.

Act 706 of flow diagram 700 includes receiving additional user input directed to configuring the system to cause presentation of beat and/or downbeat cues during playback of the audio signal. In some instances, the additional user input directed to configuring the system to cause presentation of beat and/or downbeat cues during playback of the audio signal comprises user input activating a metronome playback mode. In some implementations, the beat and/or downbeat cues comprise audible cues or visual cues.

Act 708 of flow diagram 700 includes causing playback of the audio signal.

Act 710 of flow diagram 700 includes using the beat metadata to cause presentation of the beat and/or downbeat cues during the playback of the audio signal, wherein the beat and/or downbeat cues are caused to be presented in accordance with the timestamps of the beats and/or downbeats for the audio signal represented in the beat metadata. In some examples, using the beat metadata to cause presentation of the beat and/or downbeat cues during playback of the audio signal comprises: (i) reading the timestamps of the beats and/or downbeats for the audio signal represented in the beat metadata, and (ii) when playback of the audio signal reaches one of the timestamps of the beats and/or downbeats for the audio signal represented in the beat metadata, causing presentation of a beat and/or downbeat cue. In some instances, the timestamps of the beats and/or downbeats for the audio signal represented in the beat metadata comprise beat timestamps and downbeat timestamps. In some implementations, a beat cue is caused to be presented when playback of the audio signal reaches one of the beat timestamps, and a downbeat cue is caused to be presented when playback of the audio signal reaches one of the downbeat timestamps. The downbeat cue can be different from the beat cue.

Act 712 of flow diagram 700 includes receiving further user input directed to increasing beat subdivision.

Act 714 of flow diagram 700 includes causing presentation of subdivided beat cues in addition to the beat and/or downbeat cues.

Act 716 of flow diagram 700 includes receiving further user input directed to decreasing beat subdivision.

Act 718 of flow diagram 700 includes selectively refraining from causing presentation of a beat and/or downbeat cue when playback of the audio signal reaches at least some of the timestamps of the beats and/or downbeats for the audio signal represented in the beat metadata.

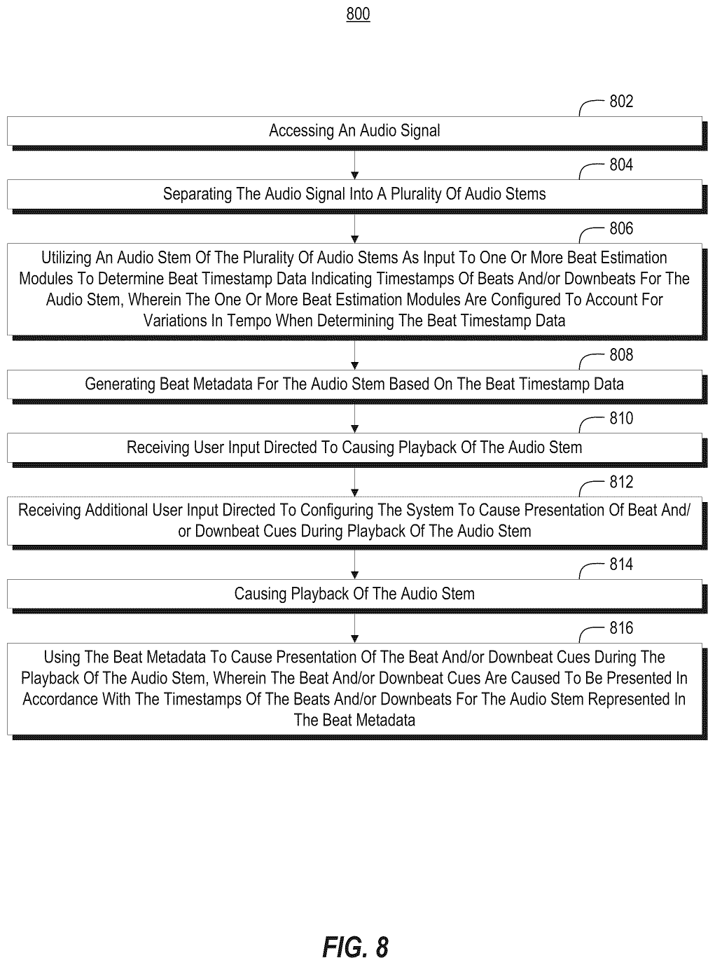

Act 802 of flow diagram 800 of FIG. 8 includes accessing an audio signal.

Act 804 of flow diagram 800 includes separating the audio signal into a plurality of audio stems.

Act 806 of flow diagram 800 includes utilizing an audio stem of the plurality of audio stems as input to one or more beat estimation modules to determine beat timestamp data indicating timestamps of beats and/or downbeats for the audio stem, wherein the one or more beat estimation modules are configured to account for variations in tempo when determining the beat timestamp data.

Act 808 of flow diagram 800 includes generating beat metadata for the audio stem based on the beat timestamp data.

Act 810 of flow diagram 800 includes receiving user input directed to causing playback of the audio stem.

Act 812 of flow diagram 800 includes receiving additional user input directed to configuring the system to cause presentation of beat and/or downbeat cues during playback of the audio stem.

Act 814 of flow diagram 800 includes causing playback of the audio stem.

Act 816 of flow diagram 800 includes using the beat metadata to cause presentation of the beat and/or downbeat cues during the playback of the audio stem, wherein the beat and/or downbeat cues are caused to be presented in accordance with the timestamps of the beats and/or downbeats for the audio stem represented in the beat metadata.

FIG. 9 illustrates example components of a system 900 that may comprise or implement aspects of one or more disclosed embodiments. For example, FIG. 9 illustrates an implementation in which the system 900 includes processor(s) 902, storage 904, sensor(s) 906, I/O system(s) 908, and communication system(s) 910. Although FIG. 9 illustrates a system 900 as including particular components, one will appreciate, in view of the present disclosure, that a system 900 may comprise any number of additional or alternative components.

The processor(s) 902 may comprise one or more sets of electronic circuitries that include any number of logic units, registers, and/or control units to facilitate the execution of computer-readable instructions (e.g., instructions that form a computer program). Such computer-readable instructions may be stored within storage 904. The storage 904 may comprise physical system memory and may be volatile, non-volatile, or some combination thereof. Furthermore, storage 904 may comprise local storage, remote storage (e.g., accessible via communication system(s) 910 or otherwise), or some combination thereof. Additional details related to processors (e.g., processor(s) 902) and computer storage media (e.g., storage 904) will be provided hereinafter.

As will be described in more detail, the processor(s) 902 may be configured to execute instructions stored within storage 904 to perform certain actions. In some instances, the actions may rely at least in part on communication system(s) 910 for receiving data from remote system(s) 912, which may include, for example, separate systems or computing devices, sensors, and/or others. The communications system(s) 910 may comprise any combination of software or hardware components that are operable to facilitate communication between on-system components/devices and/or with off-system components/devices. For example, the communications system(s) 910 may comprise ports, buses, or other physical connection apparatuses for communicating with other devices/components. Additionally, or alternatively, the communications system(s) 910 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 9 illustrates that a system 900 may comprise or be in communication with sensor(s) 906. Sensor(s) 906 may comprise any device for capturing or measuring data representative of perceivable phenomenon. By way of non-limiting example, the sensor(s) 906 may comprise one or more image sensors, microphones, thermometers, barometers, magnetometers, accelerometers, gyroscopes, and/or others.

Furthermore, FIG. 9 illustrates that a system 900 may comprise or be in communication with I/O system(s) 908. I/O system(s) 908 may include any type of input or output device such as, by way of non-limiting example, a display, a touch screen, a mouse, a keyboard, a controller, a speaker and/or others, without limitation.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are one or more “physical computer storage media” or “hardware storage device(s).” Computer-readable media that merely carry computer-executable instructions without storing the computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in hardware in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Those skilled in the art will appreciate that at least some aspects of the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, at least some of the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g., as separate threads).

One will also appreciate how any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with the content from any of the other figures.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for facilitating beat estimation and playback, comprising:
one or more processors; and
one or more computer-readable recording media that store instructions that are executable by the one or more processors to configure the system to:
access an audio signal;
utilize the audio signal as input to one or more beat estimation modules to determine beat timestamp data indicating timestamps of beats and/or downbeats for the audio signal, wherein the one or more beat estimation modules are configured to account for variations in tempo when determining the beat timestamp data;
generate beat metadata for the audio signal based on the beat timestamp data;
receive user input directed to causing playback of the audio signal;
receive additional user input directed to configuring the system to cause presentation of beat and/or downbeat cues during playback of the audio signal;
cause playback of the audio signal; and
use the beat metadata to cause presentation of the beat and/or downbeat cues during the playback of the audio signal, wherein the beat and/or downbeat cues are caused to be presented in accordance with the timestamps of the beats and/or downbeats for the audio signal represented in the beat metadata.

2. The system of claim 1, wherein the audio signal comprises an audio recording of a song.

3. The system of claim 1, wherein the audio signal comprises an audio stem separated from an audio recording of a song.

4. The system of claim 1, wherein the one or more beat estimation modules utilize a combination of Fourier transforms, neural networks, and probabilistic models to determine the beat timestamp data.

5. The system of claim 1, wherein the additional user input directed to configuring the system to cause presentation of beat and/or downbeat cues during playback of the audio signal comprises user input activating a metronome playback mode.

6. The system of claim 1, wherein the beat and/or downbeat cues comprise audible cues or visual cues.

7. The system of claim 1, wherein using the beat metadata to cause presentation of the beat and/or downbeat cues during playback of the audio signal comprises:
reading the timestamps of the beats and/or downbeats for the audio signal represented in the beat metadata; and
when playback of the audio signal reaches one of the timestamps of the beats and/or downbeats for the audio signal represented in the beat metadata, causing presentation of a beat and/or downbeat cue.

8. The system of claim 7, wherein the timestamps of the beats and/or downbeats for the audio signal represented in the beat metadata comprise beat timestamps and downbeat timestamps, wherein a beat cue is caused to be presented when playback of the audio signal reaches one of the beat timestamps, and wherein a downbeat cue is caused to be presented when playback of the audio signal reaches one of the downbeat timestamps, wherein the downbeat cue is different from the beat cue.

9. The system of claim 1, wherein the instructions are executable by the one or more processors to configure the system to:
receive further user input directed to increasing beat subdivision; and
cause presentation of subdivided beat cues in addition to the beat and/or downbeat cues.

10. The system of claim 1, wherein the instructions are executable by the one or more processors to configure the system to:
receive further user input directed to decreasing beat subdivision; and
selectively refrain from causing presentation of a beat and/or downbeat cue when playback of the audio signal reaches at least some of the timestamps of the beats and/or downbeats for the audio signal represented in the beat metadata.

11. A system for facilitating beat estimation and playback, comprising:
one or more processors; and
one or more computer-readable recording media that store instructions that are executable by the one or more processors to configure the system to:
receive beat metadata for an audio signal, wherein the beat metadata is generated based on beat timestamp data indicating timestamps of beats and/or downbeats for the audio signal, wherein the beat timestamp data is generated by utilizing the audio signal as input to one or more beat estimation modules that are configured to account for variations in tempo when determining the beat timestamp data;
receive user input directed to causing playback of the audio signal;
receive additional user input directed to configuring the system to cause presentation of beat and/or downbeat cues during playback of the audio signal;
cause playback of the audio signal; and
use the beat metadata to cause presentation of the beat and/or downbeat cues during the playback of the audio signal, wherein the beat and/or downbeat cues are caused to be presented in accordance with the timestamps of the beats and/or downbeats for the audio signal represented in the beat metadata.

12. The system of claim 11, wherein the audio signal comprises an audio recording of a song.

13. The system of claim 11, wherein the audio signal comprises an audio stem separated from an audio recording of a song.

14. The system of claim 11, wherein the additional user input directed to configuring the system to cause presentation of beat and/or downbeat cues during playback of the audio signal comprises user input activating a metronome playback mode.

15. The system of claim 11, wherein the beat and/or downbeat cues comprise audible cues or visual cues.

16. The system of claim 11, wherein using the beat metadata to cause presentation of the beat and/or downbeat cues during playback of the audio signal comprises:
reading the timestamps of the beats and/or downbeats for the audio signal represented in the beat metadata; and
when playback of the audio signal reaches one of the timestamps of the beats and/or downbeats for the audio signal represented in the beat metadata, causing presentation of a beat and/or downbeat cue.

17. The system of claim 16, wherein the timestamps of the beats and/or downbeats for the audio signal represented in the beat metadata comprise beat timestamps and downbeat timestamps, wherein a beat cue is caused to be presented when playback of the audio signal reaches one of the beat timestamps, and wherein a downbeat cue is caused to be presented when playback of the audio signal reaches one of the downbeat timestamps, wherein the downbeat cue is different from the beat cue.

18. The system of claim 11, wherein the instructions are executable by the one or more processors to configure the system to:
receive further user input directed to increasing beat subdivision; and
cause presentation of subdivided beat cues in addition to the beat and/or downbeat cues.

19. The system of claim 11, wherein the instructions are executable by the one or more processors to configure the system to:
receive further user input directed to decreasing beat subdivision; and
selectively refrain from causing presentation of a beat and/or downbeat cue when playback of the audio signal reaches at least some of the timestamps of the beats and/or downbeats for the audio signal represented in the beat metadata.

20. A system for facilitating beat estimation and playback, comprising:
one or more processors; and
one or more computer-readable recording media that store instructions that are executable by the one or more processors to configure the system to:
access an audio signal;
separate the audio signal into a plurality of audio stems;
utilize an audio stem of the plurality of audio stems as input to one or more beat estimation modules to determine beat timestamp data indicating timestamps of beats and/or downbeats for the audio stem, wherein the one or more beat estimation modules are configured to account for variations in tempo when determining the beat timestamp data;
generate beat metadata for the audio stem based on the beat timestamp data;
receive user input directed to causing playback of the audio stem;
receive additional user input directed to configuring the system to cause presentation of beat and/or downbeat cues during playback of the audio stem;
cause playback of the audio stem; and
use the beat metadata to cause presentation of the beat and/or downbeat cues during the playback of the audio stem, wherein the beat and/or downbeat cues are caused to be presented in accordance with the timestamps of the beats and/or downbeats for the audio stem represented in the beat metadata.
